(19) United States
(12) Patent Application Publication
(10) Pub. No.: US 2009/0132556 A1
(43) Pub. Date: May 21, 2009

(54) OFFLINE OPERATIONS FOR ONLINE APPLICATIONS

(76) Inventors: Nitin Gupta, Ithaca, NY (US); Jayavel Shanmugasundaram, Santa Clara, CA (US); Fan Yang, Mountain View, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/941,746

(22) Filed: Nov. 16, 2007

(51) Int. Cl. G06F 7/00; G06F 17/00

(52) U.S. Cl. 707/100; 707/E17.116; 715/234

(57) ABSTRACT

Subject matter disclosed herein may relate to enabling offline operations for online applications.

### FIELD

Subject matter disclosed herein may relate to enabling offline operations for online applications.

### BACKGROUND

The success of World Wide Web (Web) based applications, such as, for example, Web 2.0 applications, continues to change the way the Internet in general, and the Web in particular, is utilized. Rather than being merely a convenient way to publish information, web pages may be transformed into Web-based computing platforms. Compared with desktop applications, online systems may bring benefits such as, for example, universal accessibility and the ability to readily share and cooperate with others. However, web-based applications may have problems such as possible Internet connectivity issues related to outages, reduced bandwidth, and/or temporary loss of connection, such as in an airplane, for example, that may reduce the usability of the web-based applications.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram illustrating an example system and/or process for enabling offline operations for an online application in accordance with one or more embodiments;

FIG. 2 is a flow diagram illustrating an example process for enabling offline operations for an online application in accordance with one or more embodiments;

FIG. 3 is a block diagram illustrating an example structure of an online application with offline operation support in accordance with one or more embodiments;

FIG. 4 is a block diagram illustrating example run-time objects created for an example online application in accordance with one or more embodiments;

FIG. 5 is a block diagram illustrating an example local data cache architecture in accordance with one or more embodiments;

FIG. 6 is a flow diagram of an example process for updating a template in accordance with one or more embodiments; and

FIG. 7 is a block diagram illustrating an example computing platform implemented in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include algorithms, programs and/or symbolic representations of operations on data bits or binary digital signals within a computer memory capable of performing one or more of the operations described herein. Although the scope of claimed subject matter is not limited in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Likewise, although the scope of claimed subject matter is not limited in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor. For an embodiment, instructions may comprise run-time objects, such as, for example, Java and/or Javascript objects. However, these are merely examples of an instruction, and the scope of claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, estimating, incorporating, adjusting, modeling, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

As discussed above, web applications may experience problems associated with temporary loss of connectivity. Therefore, offline support for online applications such as web-based applications may be desirable.

As used herein, the terms “web application” and “web-based application” are used interchangeably, and are meant to denote any application that takes advantage of at least one of the Web's possible features, such as, for example, web-based communities and/or hosted services. Also, as used herein, the term “online application” is meant to include web applications, but may also include applications that utilize one or more resources accessible via a network other than the Web.

One way to provide offline support for online applications is for application programmers to develop executable code for both client and server systems. Logic for supporting the offline operations may be replicated in the client system. Such replication and specialized application development may result in extra work and expense during application development and may require substantial expertise to implement, and may also make system maintenance difficult. Further, many web applications provide pages that may be dynamically generated based on changing business data. Users of the application may be granted permission to update some of the pages based on the application logic. Offline support for such applications may mean allowing users to view pages and perform updates as if the users were online. The system may cache the data for the pages and may perform logic for the updates and may present updated pages to the users. As a result of offline updates, with limited cached data on the client system, the application may not be able to produce meaningfully updated pages. Further, because multiple users may perform offline updates, conflicting actions from various users may result in difficulties while merging the offline updates into the system.

For an embodiment, an online application may be expressed in what may be referred to as an intermediate modeling language (IML). IML may be platform independent, and may utilize run-time interpreters to allow application developers to define the application logic once and have the defined functionalities executed on either a client or a server, or both the client and the server. If the client system is online, the functionalities may be partitioned between the client and the server. How the functionalities are split may depend, at least is part, on security and/or performance criteria. For an embodiment, the system may automatically partition functionality across client and server to improve performance based on any of a range of possible performance criteria e.g., users response time, system throughput, etc. Developers of web applications may also enforce certain constraints on allowable partitions by marking some functionalities as “confidential” that are not allowed to be performed at the client side. If the client is in an offline state, as much functionality as possible, which satisfies security constraints if any, may be maintained on the client using cached data. In response to a reconnection of the client to the server, local data that may have been updated during offline operations may be synchronized with the server, and possible conflicts may be detected and resolved during synchronization. For one or more embodiments, the switch between online and offline modes of operation may be transparent to users. These are merely examples of some of the functionality that may be defined using IML, and the scope of claimed subject matter is not limited in these respects.

Although the embodiments described herein utilize IML, other embodiments are possible using other programming and/or modeling languages. Also, the embodiments for IML described herein are merely example embodiments, and the scope of claimed subject matter is not limited in these respects.

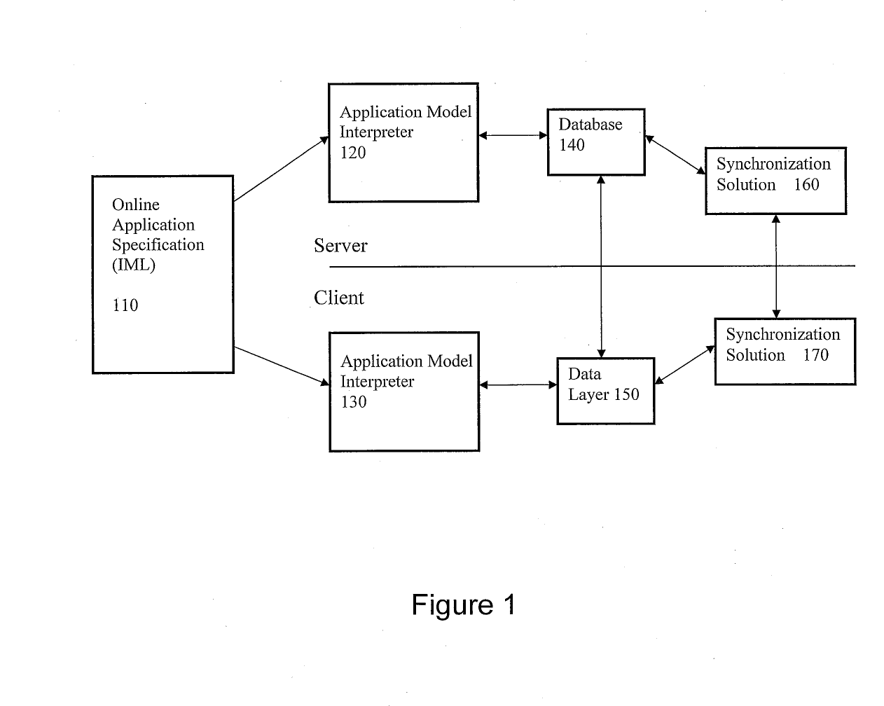

FIG. 1 is a block diagram illustrating an example embodiment of a system and/or process for enabling offline operations for an online application. Block 110 represents an online application specification, which may also be referred to as an application definition. For this embodiment, the application is defined in IML, although the scope of claimed subject matter is not limited in this respect. Run-time interpreters for both a server computing platform and a client computing platform (application model interpreters 120 and 130, respectively), may be utilized to generate instructions to be executed on either the client or the server, or on both the client and the server. Thus, an application developer may specify desired functionalities a single time in the online application specification using IML, and instructions for both the client and the server may be automatically generated by application model interpreters 120 and 130.

Application model interpreter 120 may also generate instructions for managing data in a database 140. For an embodiment, application data may be stored in a backend database management system (DBMS), and the application model interpreter 120 may generate code such as a structured query language (SQL) statement for the DBMS to initialize and manage the application data. Also for an embodiment, if the client system is online during operation, data may be retrieved from and/or transmitted to database 140. Application model interpreter 130 may generate instructions for providing a data layer 150 that may include, for example, a local data cache structure. If the client is in an offline state during operation, as much functionality as possible may be maintained on the client using data from the local data cache. Application model interpreters 120 and 130 may also generate instructions for providing a synchronization solution divided between the server and client, labeled synchronization solutions 160 and 170, respectively. In response to a reconnection of the client to the server, local data that may have been updated during offline operations may be synchronized with the server, and possible conflicts may be detected and resolved during synchronization. For one or more example embodiments, the functionalities of switching between online and offline modes of operation may be implemented as part of one or more application model interpreters. These functionalities may be hardcoded into the system, rather than being generated at runtime by the application model interpreter. Further, the functionalities of switching between online and offline modes of operation may be transparent to users, and the system may automatically detect network connection conditions and work under the appropriate mode of operation accordingly.

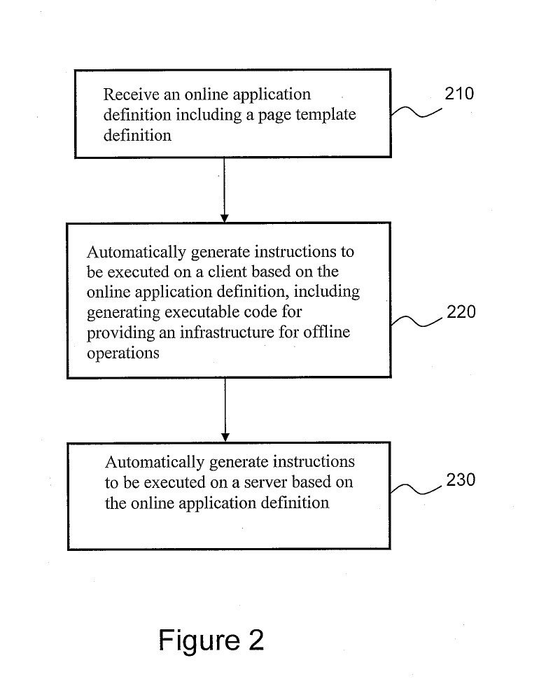

FIG. 2 is a flow diagram illustrating an example embodiment of a process for enabling offline operations for an online application. At block 210, an online application definition is received. The definition may include a page template definition. For an embodiment, the definition may be expressed in IML, although the scope of claimed subject matter is not limited in this respect. At block 220, instructions to be executed on a client computing platform may be automatically generated. The instructions may be based on the online application definition, and may include instructions for providing an infrastructure for supporting offline operations. At block 230, instructions to be executed on a server computing platform may be automatically generated, wherein the instructions may be based on the online application definition. For an embodiment, the processes represented by blocks 210-230 may be performed at least in part by one or more run-time interpreters, although the scope of claimed subject matter is not limited in this respect. Example processes in accordance with claimed subject matter may include all, more than all, or less than all of blocks 210-230. Further, the order of blocks 210-230 is merely an example order, and the scope of claimed subject matter is not limited in this respect.

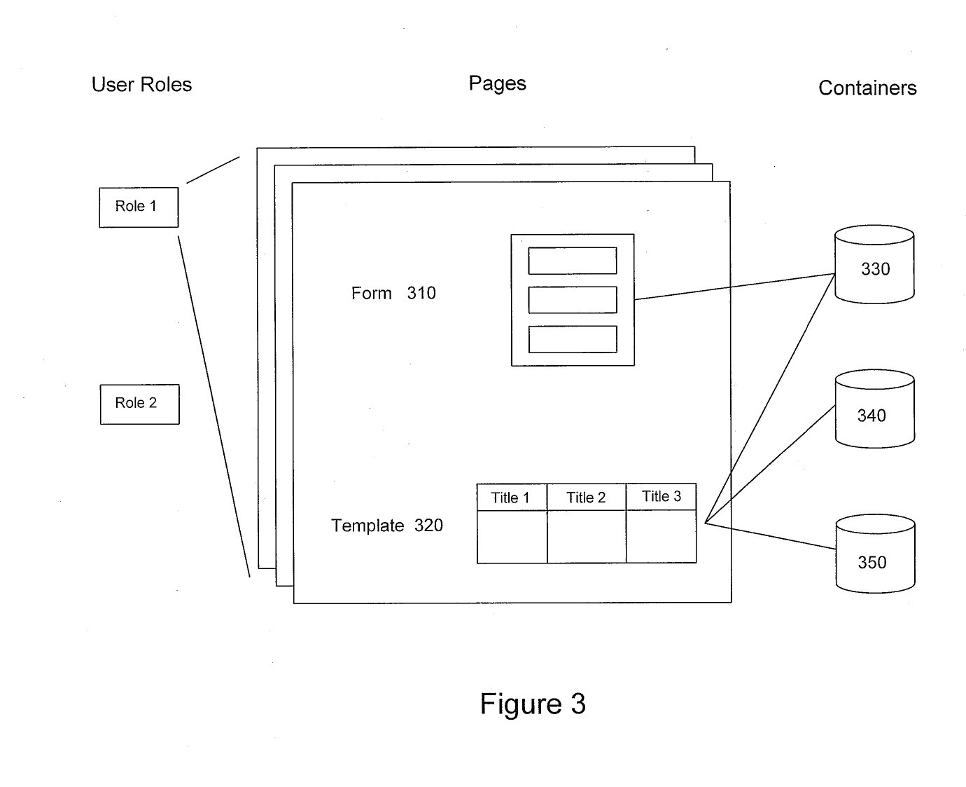

FIG. 3 is a block diagram illustrating an example embodiment of a structure of an online application with offline operation support. For an embodiment, users may be assigned one or more “roles”, such as, for example, role 1 and/or role 2 as illustrated in FIG. 3. Roles may define which pages are accessible by the various users assigned to those roles. For this example embodiment, Role 1 is used, and is assigned to all users. Other embodiments may utilize more than one role.

FIG. 3 also illustrates web pages that are viewable for Role 1. For this example embodiment, each web page may comprise one or more forms, such as, for example, form 310, and one or more templates, such as, for example, template 320. The forms and templates may be utilized by users to update and/or view data. For this example, the data is represented by containers 330, 340, and 350. Although FIG. 3 is depicted with a particular arrangement of roles, pages, and containers, other embodiments may utilize other arrangements or configurations, and the scope of claimed subject matter is not limited in this respect.

As previously mentioned, for example embodiments described herein, online application specifications may be defined in IML. For an embodiment, IML may include definitions for roles, pages, containers, etc. During runtime, the IML definitions may be automatically interpreted and runtime objects may be created at both the front end (client) and back end (server) as Java and Javascript objects, although the scope of claimed subject matter is not limited in this respect. In the discussion below, an example is given of possible grammar for IML. Of course, other embodiments may utilize grammar that varies from the examples given.

IML may be used to specify any of a wide range of aspects of an online application. IML may specify a database schema definition (DSD) to provide for the storing of data, graphical user interface (GUI) components specification (GUIS) to allow users to interact with the application, and a page view specification (PVS) that may include logic to display data as dynamically generated pages. For an embodiment, a graphical development platform may be provided to allow application developers to create online applications in a WYS/WYG style. For such an embodiment, the graphical development platform may generate an IML definition for the application.

For an embodiment, the DSD may define a database schema that may include Entities and Relationships between Entities. Entity and relationship data may be stored in a database schema that includes one or more “containers”, as described more fully below. The PVS may include a specification for displaying data as tables in one or more web pages. The displayed results may be referred to as templates. The definition of templates may include nested relational algebra expressions which may specify the structure of the nested table and the query to generate the data in the table. The template definitions may also specify additional properties for columns of the table, such as, for example, “updateable”. The GUIS may include a specification for interactive components of the application.

For an embodiment, “role_def” may provide a list of web pages for each role in the application. Also for this embodiment, “page_def” may contain the definitions of forms and templates for each page, and “container_def” may define a data schema. The following are further examples of possible IML grammar for this embodiment:
app₁₃ def:—(role_def)*|(container_def)*
role_def:—‘ROLE’ role_name ‘WITH’ page_list
page_list:—page_def(‘,’ page_def)*
page_def:—‘PAGE’ name ‘WITH’ (template_def|form_def)+
template_def:—‘TEMPLATE’ template_name ‘AS’ nested_relational_algebra (‘WITH’ column_specification)?
column_spec:—(nested_name|default_pos(‘AS’ ‘UPDATEABLE’)? (‘CAPTION’ text)?(‘POSITION’ pos)?(‘OPTIONS’ option)?‘SHOW_CURRENT_USER’?‘EDIT_CURRENT_USER’?)*
nested_name:—column_name(‘.’ column_name)*
container_def:—‘CONTAINER’ name(column_def)*
column_def:—‘COLUMN’ name ‘TYPE’ type
type:—primitive_type|reference_type
form_def:—‘FORM’ form_name ‘AS’ component_definition*
component_def:—name ‘TYPE’ type ‘FOR’ nested_name(‘OPTIONS’ options)? (‘DEFAULT’ value)?

The nested_relational_algebra expressions above may comprise nested relational algebra expressions that may define a nested structure of a template and the query to compute the data shown in the template. The column_spec expression defines which columns of which nested table are updateable and also defines which captions are displayed while the template is shown.

As an example of an online application, consider an application where users may post items that they want to give away and/or place requests for items that others have posted. A user may also, for this example, view a list of items posted by that user and also a list of users that have posted requests for those items. For this application, there is a single role, “everyone” (all users assigned to this role), and the role can view two pages, one page “Posting” for posting items to give away and for showing a list of already-posted items by a user and another page “Listing” for viewing all the items in the system and for placing requests for items if desired. Below is an example online application definition for this example in IML:
CONTAINER ‘Users’ COLUMN username TYPE string
   COLUMN Email TYPE email
CONTAINER ‘Offers’ COLUMN title TYPE string
   COLUMN description TYPE text
   COLUMN weight TYPE number
CONTAINER ‘Offer’ COLUMN owner TYPE Users
   COLUMN item TYPE Offers
CONTAINER ‘Request’ COLUMN requester TYPE Users
   COLUMN item TYPE Offers
ROLE ‘everyone’ WITH
   PAGE ‘Listing’
      TEMPLATE All Listing AS
      v_{Offers.title}II_{Offers.title,Users.name}(Offers [symbol] Owner [symbol] Users) [symbol]
      v_{Offers.title}II_{Offers.title,Users.name}(Offers [symbol] Request [symbol] Users)
      WITH
         1 CAPTION ‘Title’
         2 CAPTION ‘Owner’
         3 CAPTION ‘Request’ EDIT CURRENT USER
         OPTIONS ‘Request Item’ ‘Cancel Request’
   PAGE ‘Posting’
      FORM Offer Post Form AS
      “Title” TYPE text FOR Offers.name
      “Description”: TYPE textarea FOR Offers.description
      “Weight” TYPE number FOR offer.weight
      “Owner”: TYPE ref FOR Offers.owner.Users.name
      DEFAULT CURRENT USER
      TEMPLATE My Listing AS
      v_{Offers.title}II_{Offers.title}δ_{Users.name=}CURRENT_USER(Offers [symbol] Owner [symbol] Users) [symbol]
      v_{Offers.title}II_{Offers.title,Users.name}(Offers [symbol] Request [symbol] Users)
      WITH
         1 CAPTION ‘Title’

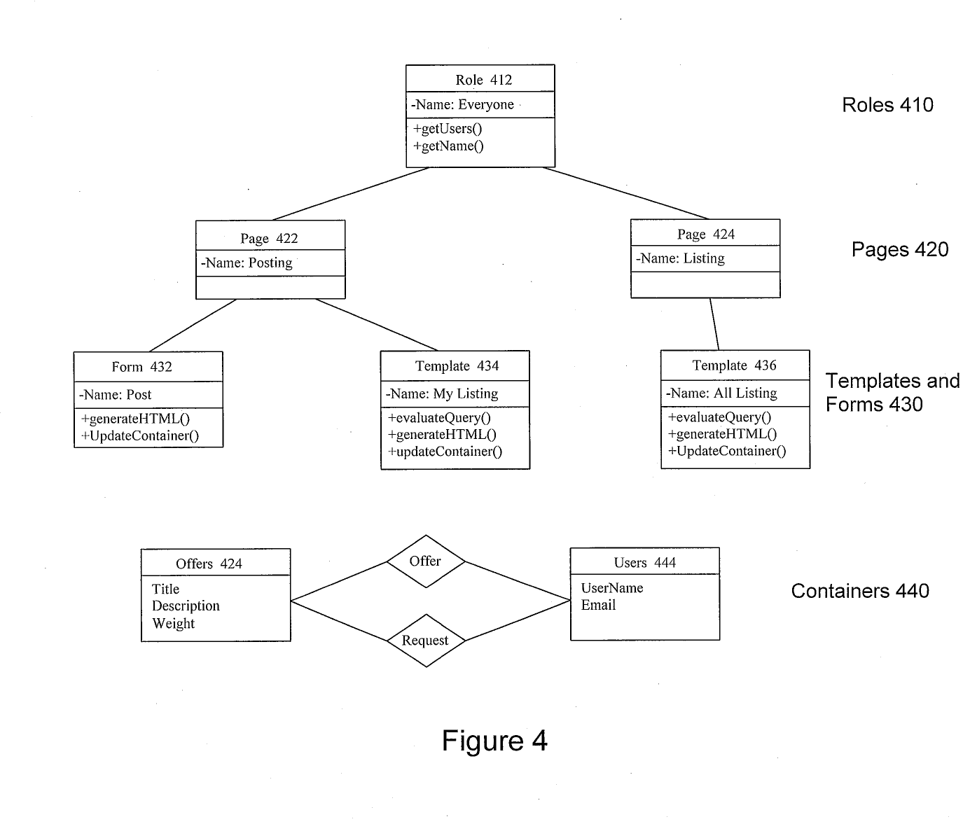

FIG. 4 is a block diagram illustrating example run-time objects created for the example online application defined in IML above. The run-time objects depicted in FIG. 4 include roles 410, pages 420, templates and forms 430, and containers 440. The definitions for these objects are given above. Roles 410 for this example include role 412, named “everyone”. Assigned to role “everyone” are pages 422 and 424, named “Posting” and “Listing”, respectively. Page “Posting” includes form 432, named “Post” and template 434, named “My Listing”. Page “Listing” for this example includes template 436, named “All Listing”. Containers 440 for this example include “Offers” 424, “Users” 444, as well as containers named “Offer” and “Request”, as depicted in FIG. 4.

A possible benefit of the high-level, platform independent IML specification provided above is that manual replication of the application logic across the client and server computing platforms may be avoided. The same application specified in IML may be used to generate executable code (instructions) at both the front end (client) and back end (server). The infrastructure for supporting offline operations may also be automatically generated based on the IML definitions. Application developers therefore are able to focus on the core logic of the application without extra effort to make the application available and functional offline.

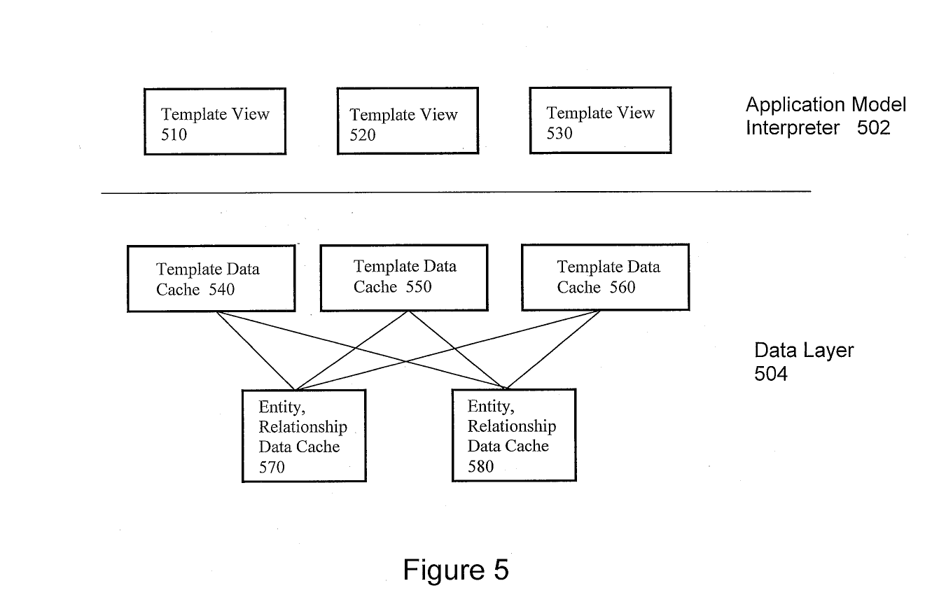

For an embodiment, data layer 150 as illustrated in FIG. 1 and data layer 504 as discussed in connection with FIG. 5 below, may provide data to the application model interpreter. If the client is connected to the server (i.e., the system is “online”), the client may contact the server directly to fetch data and may store the data in a local data cache. If the system goes offline (i.e., the client is not connected to the server), the client may still be able to provide data using locally cached data.

FIG. 5 is a block diagram illustrating an example embodiment of a local data cache architecture. For this example embodiment, data may be cached at the template level as well as at the entity/relationship (container) level. For this example, three template views may be defined, labeled here as template views 510, 520, and 530. The template definitions may be utilized by an application model interpreter 502 to create the cache structure represented by data layer 504. For this example, data layer 504 may include data caches for each template. Template data caches 540, 550, and 560 may be associated with corresponding template views 510, 520, and 530, respectively. Entity/relationship data caches 570 and 580 may be made available to each of template data caches 540, 550, and 560. However, the data cache architecture depicted in FIG. 5 is merely an example structure, and the scope of claimed subject matter is not limited in these respects.

For an embodiment, for security reasons, only data that are contained in the visible templates are delivered from the server to the client. Data layer 504 may automatically store the data in the template data cache associated with the particular visible template. Data layer 504 may also extract out the data for entities and relationships underlying the template definitions. Because templates may share entity/relationship data, such data may be aggregated at the entity/relationship level, for example at entity/relationship data caches 570 and 580.

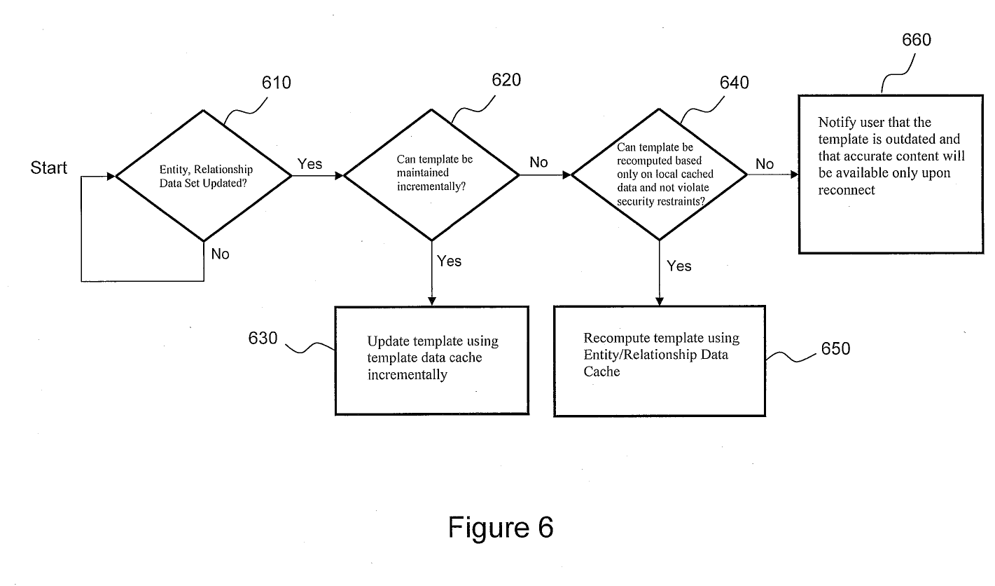

If any entity/relationship data is updated by a user while the system is online (an online update), a request may be sent to the server, and an updated page view may be generated. During an offline state, the application may log user updates and may attempt to generate updated page views locally on the client using cached data. From the underlying structure of the data layer, the application can determine which templates may be updated. For an embodiment, a “best efforts” based process may be utilized to update the template or templates. One such possible process is discussed below in connection with FIG. 6.

For one or more embodiments, any of several possible strategies may be employed to maintain and/or manage data at the client, depending at least in part on available storage and computing resources. For an embodiment, all application data sent from the server to the client may be cached for an application and the data may be managed at both the template level and the entity/relationship level. For another embodiment, the amount and/or size of the cached data may be limited based at least in part on the system configuration. For yet another possible embodiment, data may be cached at the template level and the data may be constructed in a relationship/entity format from the template data while the client is in the offline state, thereby saving a measure of computing cost while the client is in the online state. Of course, these are merely examples of strategies for maintaining and/or managing application data, and the scope of claimed subject matter is not limited in this respect.

The various possible strategies for maintaining and/or managing data at the client may, for one or more embodiments, either be determined by a system configuration provided by a user and/or may be determined automatically by detecting the client type (e.g., personal digital assistant, desktop computer, cellular phone, etc.). For one embodiment, the user may provide the system configuration for an embodiment at least in part by setting a browser cookies cache size.

FIG. 6 is a flow diagram of an example embodiment of a process for updating a template. For this example, the process begins at block 610, where it may be determined that an update has occurred for some entity/relationship data. In the event of such an update, processing proceeds to block 620. At block 620, a determination may be made as to whether a template associated with the updated entity/relationship data can be updated (maintained) incrementally, using data from the local template data cache. If such an update is possible, at block 630 the template may be updated using data from the template data cache. If at block 620 the determination is made that the template can not be maintained incrementally, processing may proceed to block 640. At block 640, a determination may be made as to whether the template may be recomputed based on only locally cached data and as to whether the recomputation would violate security constraints, if any. Such a determination may be made possible due to the application model interpreter's knowledge of the nested relational algebra expressions in the IML application specification, thereby understanding how to recreate the template data from the underlying entity/relationship data. If such a re-computation is possible, processing may proceed to block 650 where the template may be re-computed using data from a local entity/relationship data cache. If such a re-computation is not possible, at block 660 a user may be notified that the template is outdated and that accurate template content may not be available until the system is returned to an online state. In this manner, the user may be presented with a warning or alert that the new view is unavailable or obsolete. Otherwise, if the new view can be calculated accurately using locally cached data, the new view may be presented to the user just as if the update had occurred on the server.

In response to the connection to the server being re-established, all updates performed while the client was offline may be sent to the server. During the offline period, data on the server may be readily updated by other clients for applications providing for multiple users of the system. In this case, a user's offline updates may not be based on the most recent, up-to-date data. For an embodiment, values updated on the client during an offline period may be checked upon reconnection with the client. If the value has not been changed on the server during the offline period, the application may update the server with the updated value. If the value was changed on the server during the offline period, the application may notify the user of the latest value and may also ask the user for confirmation regarding whether the user desires to continue the update or otherwise.

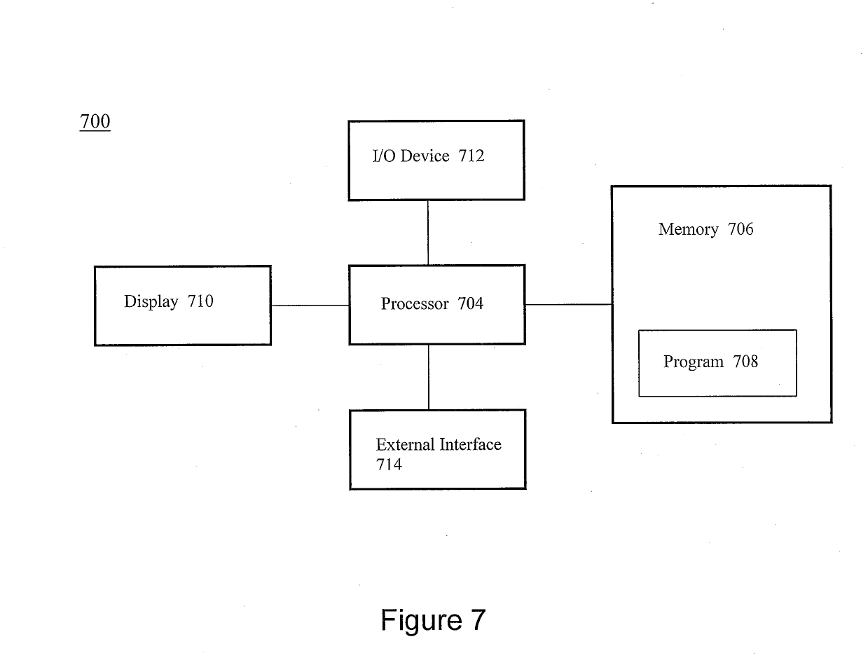

Referring to FIG. 7, a block diagram illustrates a computing platform 700 according to one or more embodiments, although the scope of claimed subject matter is not limited in this respect. Computing platform 700 may be utilized as a client and/or as a server in the embodiments described above, although the scope of claimed subject matter is not limited in this respect. Computing platform 700 may include more and/or fewer components than those shown in FIG. 7. However, generally conventional components may not be shown, for example, a battery, a bus, and so on. Further, the term “computing platform” as used herein is meant to denote any of a wide range of devices or components capable of executing instructions. For example, a computing platform may comprise a notebook computer and/or a desktop computer and/or a server and/or a cellular phone and/or a portable media device and/or a personal digital assistant and/or a gaming console and/or a television, etc. However, these are merely examples of computing platforms, and the scope of claimed subject matter is not limited in this respect.

Computing platform 700, as shown in FIG. 7 may be utilized to tangibly embody a computer program and/or graphical user interface by providing hardware components on which the computer program and/or graphical user interface may be executed. Computing platform 700 may be utilized to tangibly embody all or a portion of the procedures and/or systems of FIGS. 1-6, for example. For an embodiment, computing platform 700 may be used to execute an application model interpreter, such as, for example, interpreter 120 and/or 130. Such a procedure, computer program and/or machine readable instructions may be tangibly stored on a computer and/or machine readable storage medium such as a compact disk (CD), digital versatile disk (DVD), flash memory device, hard disk drive (HDD), and so on. As shown in FIG. 7, computing platform 700 may be controlled by processor 704, including one or more auxiliary processors (not shown). Processor 704 may comprise a central processing unit such as a microprocessor or microcontroller for executing programs, performing data manipulations, and controlling the tasks of computing platform 700. Auxiliary processors may manage input/output, perform floating point mathematical operations, manage digital signals, perform fast execution of signal processing algorithms, operate as a back-end processor and/or a slave-type processor subordinate to processor 704, operate as an additional microprocessor and/or controller for dual and/or multiple processor systems, and/or operate as a coprocessor and/or additional processor. Such auxiliary processors may be discrete processors and/or may be arranged in the same package as processor 704, for example, in a multicore and/or multithreaded processor; however, the scope of claimed subject matter is not limited in these respects.

Communication with processor 704 may be implemented via a bus (not shown) for transferring information among the components of computing platform 700. A bus may include a data channel for facilitating information transfer between storage and other peripheral components of computing platform 700. A bus further may provide a set of signals utilized for communication with processor 704, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of claimed subject matter is not limited in this respect.

Other components of computing platform 700 may include, for example, memory 706, including one or more auxiliary memories (not shown). Memory 706 may provide storage of instructions and data for one or more programs 708 to be executed by processor 704, such as all or a portion of the procedures of FIGS. 1-6, for example. Memory 706 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 706 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 706 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 700 further may include a display 710. Display 710 may comprise a video display adapter having components, including, for example, video memory, a buffer, and/or a graphics engine. Such video memory may be, for example, video random access memory (VRAM), synchronous graphics random access memory (SGRAM), windows random access memory (WRAM), and/or the like. Display 710 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth.

Computing platform 700 further may include one or more I/O devices 712. I/O device 712 may comprise one or more I/O devices 712 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like.

Computing platform 700 further may include an external interface 714. External interface 714 may comprise one or more controllers and/or adapters to prove interface functions between multiple I/O devices 712. For example, external interface 714 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 712.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
receiving a web application definition including a page template definition;
automatically generating instructions to be executed on a client based on the web application definition, including generating instructions for providing an infrastructure for offline operations; and
automatically generating instructions to be executed on a server based on the web application definition.

2. The method of claim 1, wherein the web application definition comprises a template definition.

3. The method of claim 1, wherein the web application definition comprises a graphical user interface definition.

4. The method of claim 1, wherein the web application definition comprises entity and relationship definitions.

5. The method of claim 1, wherein said generating instructions for providing the infrastructure for offline operations comprises generating instructions for creating a data cache structure.

6. The method of claim 5, wherein said generating instructions for creating the data cache structure comprises generating instructions for creating a local data cache on the client.

7. The method of claim 6, wherein said generating instructions for creating the data cache structure comprises generating instructions for automatically fetching data from the server and updating the local data cache if the client is in an online state.

8. The method of claim 7, wherein said generating instructions for creating the data cache structure comprises generating instructions for fetching data from the local cache if the client is in an offline state.

9. The method of claim 8, wherein said generating instructions for creating the local data cache comprises creating a template data cache.

10. The method of claim 9, wherein said generating instructions for creating the local data cache comprises creating an entity and relationship data cache.

11. The method of claim 10, wherein said generating instructions for providing the infrastructure for offline operations comprises generating instructions for updating a template using data from the template data cache in response to an update to an entity or relationship data set if the client is in the offline state and if the template is capable of being updated incrementally.

12. The method of claim 10, wherein said generating instructions for providing the infrastructure for offline operations comprises generating instructions for updating a template in response to an update of an entity or relationship data set by re-computing the template using data from the entity and relationship data cache if the client is in the offline state and if the template is not capable of being updated incrementally and if the template is capable of being recalculated using data from the entity and relationship data cache and if the recalculation would not voilate a specified security criterion.

13. The method of claim 10, wherein said generating instructions for providing the infrastructure for offline operations comprises generating instructions for notifying a user that a template is outdated in response to an update of an entity or relationship data set if the client is in the offline state and if the template is not capable of being updated incrementally and if the template is not capable of being recomputed using data from the entity and relationship data cache.

14. The method of claim 13, wherein said generating instructions for providing the infrastructure for offline operations comprises generating instructions for automatically updating the template and the local template data cache and the local entity and relationship data cache in response to the client entering the online state.

15. The method of claim 1, wherein said automatically generating instructions to be executed on the server comprises automatically generating instructions for automatically resolving conflicts arising from offline updates from multiple users to data stored at the server.

16. The method of claim 1, wherein said automatically generating instructions to be executed on the client and said automatically generating instructions to be executed on the server further comprise automatically partitioning the instructions between the client and the server based, at least in part, on performance and/or securtiy criteria.

17. An article, comprising: a storage medium having stored thereon instructions that, if executed, result in:
receiving a web application definition including a page template definition;
automatically generating instructions to be executed on a client based on the web application definition, including generating instructions for providing an infrastructure for offline operations; and
automatically generating instructions to be executed on a server based on the web application definition.

18. The article of claim 17, wherein the web application definition comprises a template definition and further comprises entity and relationship definitions.

19. The article of claim 17, wherein said generating instructions for providing the infrastructure for offline operations comprises generating instructions for creating a data cache structure including a local data cache on the client.

20. The article of claim 19, wherein said generating instructions for creating the data cache structure comprises generating instructions for automatically fetching data from the server and updating the local data cache if the client is in an online state.

21. The article of claim 20, wherein said generating instructions for creating the data cache structure comprises generating instructions for fetching data from the local cache if the client is in an offline state.

22. The article of claim 21, wherein said generating instructions for providing the infrastructure for offline operations comprises generating instructions for updating a template using data from the template data cache in response to an update to an entity or relationship data set if the client is in the offline state and if the template is capable of being updated incrementally.

23. The article of claim 17, wherein said automatically generating instructions to be executed on the server comprises automatically generating instructions for automatically resolving conflicts arising from offline updates from multiple users to data stored at the server.

24. The article of claim 17, wherein said automatically generating instructions to be executed on the client and said automatically generating instructions to be executed on the server further comprise automatically partitioning the instructions between the client and the server based, at least in part, on performance and/or securtiy criteria.

25. An apparatus, comprising:
means for receiving a web application definition including a page template definition;
means for automatically generating instructions to be executed on a client based on the web application definition, including means for generating instructions for providing an infrastructure for offline operations; and
means for automatically generating instructions to be executed on a server based on the web application definition.

26. The apparatus of claim 21, wherein the web application definition comprises a template definition and further comprises entity and relationship definitions.

27. The apparatus of claim 21, wherein said means for generating instructions for providing the infrastructure for offline operations comprises means for generating instructions for creating a data cache structure including a local data cache on the client.

28. The apparatus of claim 23, wherein said means for generating instructions for creating the data cache structure comprises means for generating instructions for automatically fetching data from the server and updating the local data cache if the client is in an online state.

29. The apparatus of claim 18, wherein said means for generating instructions for creating the data cache structure comprises means for generating instructions for fetching data from the local cache if the client is in an offline state.

30. The apparatus of claim 25, wherein said means for automatically generating instructions to be executed on the server comprises means for automatically generating instructions for automatically resolving conflicts arising from offline updates from multiple users to data stored at the server.

31. The apparatus of claim 25, wherein said means for automatically generating instructions to be executed on the client and said means for automatically generating instructions to be executed on the server further comprise means for automatically partitioning the instructions between the client and the server based, at least in part, on performance and/or securtiy criteria.
